(19) United States
(12) Patent Application Publication
(10) Pub. No.: US 2025/0156164 A1
(43) Pub. Date: May 15, 2025

(54) MODEL-SPECIFIC ASIC COMPILATION BY MODIFYING TEMPLATE MODELS

(71) Applicant: Etched.ai, Inc., Menlo Park, CA (US)

(72) Inventors: Tom SHLOMI, Menlo Park, CA (US); Gavin UBERTI, Menlo Park, CA (US)

(21) Appl. No.: 18/509,832

(22) Filed: Nov. 15, 2023

(51) Int. Cl. G06F 8/41

(52) U.S. Cl. CPC G06F 8/447

(57) ABSTRACT

Embodiments herein describe using template files for translating an existing (or base) AI model into a new AI model for a model-specific chipset. That is, instead of requiring a developer to use an AI framework to prepare new code for the new AI model, a compiler can receive a template file which indicates a base AI model (e.g., an AI model that has already been executed on the model-specific chipset) and structural parameters for the new AI model. The compiler can use the structural parameters to modify compilation data corresponding to the base AI model. The compiler can then use the modified compilation data to create code for the new AI model that executes on the model-specific chipset.

### TECHNICAL FIELD

Embodiments presented in this disclosure generally relate to using a template file to execute a new AI model on a model-specific chipset containing one or more application specific integrated circuits (ASICs).

### BACKGROUND

AI models are typically written using functions from a machine learning (ML) or artificial intelligence (AI) framework such as PyTorch (PyTorch is a trademark of The Linux Foundation) or TensorFlow (TensorFlow is a trademark of Google Inc.). A developer can use an AI framework to create a new model. That is, new AI models are often coded from “scratch” using an AI framework. However, having to write new code each time an AI model is developed can introduce errors, delay its release, and increase cost.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a workflow for executing a new AI model on a model-specific chipset, according to one embodiment.

FIG. 2 is a flowchart for executing a new AI model on a model-specific chipset using a template file, according to one embodiment.

FIG. 3 illustrates a workflow for executing a new AI model on a model-specific chipset using intermediate representations, according to one embodiment.

FIG. 4 is a flowchart for executing a new AI model on a model-specific chipset using an intermediate representation, according to one embodiment.

FIG. 5 illustrates a portion of an exemplary intermediate representation specification, according to one embodiment.

FIG. 6 is a flowchart for executing a new AI model on a model-specific chipset using a template file, according to one embodiment.

FIG. 7 illustrates an integrated circuit with a systolic array and a self-attention circuit, according to one embodiment.

FIG. 8 illustrates a package with a combined systolic array formed using a plurality of integrated circuits, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### SUMMARY

One embodiment presented in this disclosure is a method that includes receiving a template file identifying a base artificial intelligence (AI) model and structural parameters corresponding to a second AI model where the base AI model has been previously compiled to execute on a model-specific chipset, modifying compilation data corresponding to the base AI model using the structural parameters, creating, at a compiler, executable code for the second AI model using the modified compilation data, and executing the second AI model on the model-specific chipset using the executable code.

Another embodiment disclosed herein is a non-transitory computer readable medium that includes program instructions embodied therewith, the program instructions executable by a processor to perform an operation. The operation includes receiving a template file identifying a base artificial intelligence (AI) model and structural parameters corresponding to a second AI model where the base AI model has been previously compiled to execute on a model-specific chipset, modifying compilation data corresponding to the base AI model using the structural parameters, creating, at a compiler, executable code for the second AI model using the modified compilation data, and executing the second AI model on the model-specific chipset using the executable code.

Another embodiment disclosed herein is a system that includes one or more processors and a one or more memories storing a compiler which, when executed by the one or more processors, performs an operation. The operation includes receiving a template file identifying a base artificial intelligence (AI) model and structural parameters corresponding to a second AI model where the base AI model has been previously compiled to execute on a model-specific chipset, modifying compilation data corresponding to the base AI model using the structural parameters, creating, at a compiler, executable code for the second AI model using the modified compilation data, and executing the second AI model on the model-specific chipset using the executable code.

### DETAILED DESCRIPTION

Embodiments herein describe using template files for translating an existing base (or template) AI model into a new AI model for a model-specific chipset. That is, instead of requiring a developer to use an AI framework to write new code for the new AI model, a compiler can receive one or more template files which indicates a base AI model (e.g., an AI model that has already been executed on the model-specific chipset) and structural parameters for the new AI model. The compiler can use the structural parameters to modify compilation data corresponding to the base AI model. The compiler can then use the modified compilation data to create code for a new AI model that executes on the model-specific chipset. In this manner, the developer only has to provide a template file which the compiler can then use to generate a new AI model.

There are various ways in which the compiler can modify compilation data corresponding to the base AI model (also referred to as a template model). In one embodiment, the compiler uses the structural parameters provided in the template file to modify code corresponding to the base AI model. This can include structurally modifying the code, substituting parameters, both, or any other suitable modification. This substitution can be performed at a high level (e.g., in a high-level software programming language—e.g., Python, C, C++, etc.) or at a lower level in executable code (e.g., assembly code). In either case, the compiler outputs executable code that executes the new AI model (rather than the base AI model) on the model-specific chipset.

In another embodiment, the compiler can use the structural parameters to modify an intermediate representation (IR) of the base AI model. The modified IR model can then be compiled into executable code for executing the new AI model on the model-specific chipset.

While the embodiments herein describe a transformer model specific chipset as a specific example, they are not limited to such. The embodiments herein can be used to translate specialized functions for one hardware platform into any type of model-specific ASIC or chipset. Further, as used herein, a “chipset” can include only one IC (e.g., only one ASIC or GPU) or multiple ICs (e.g., multiple ASICs or GPUs).

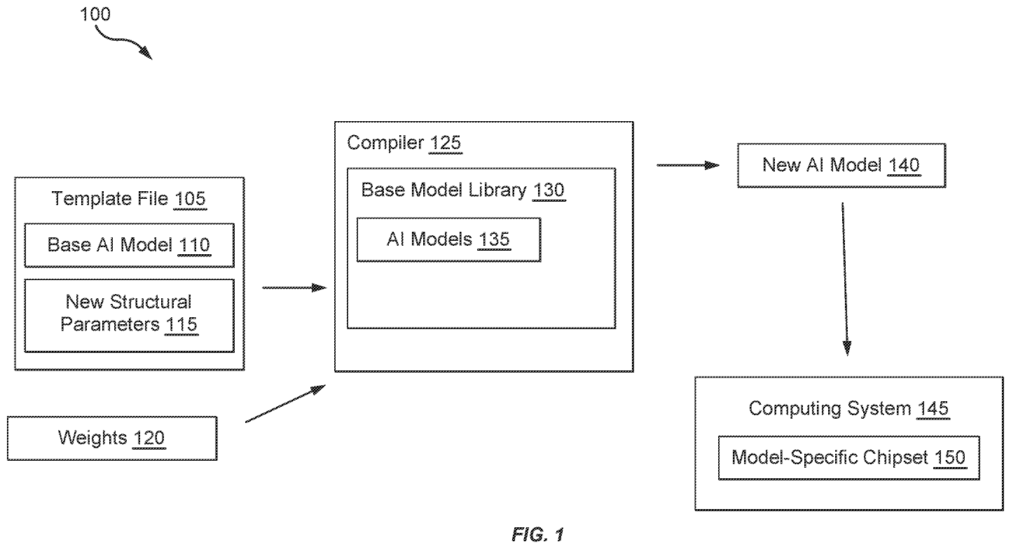

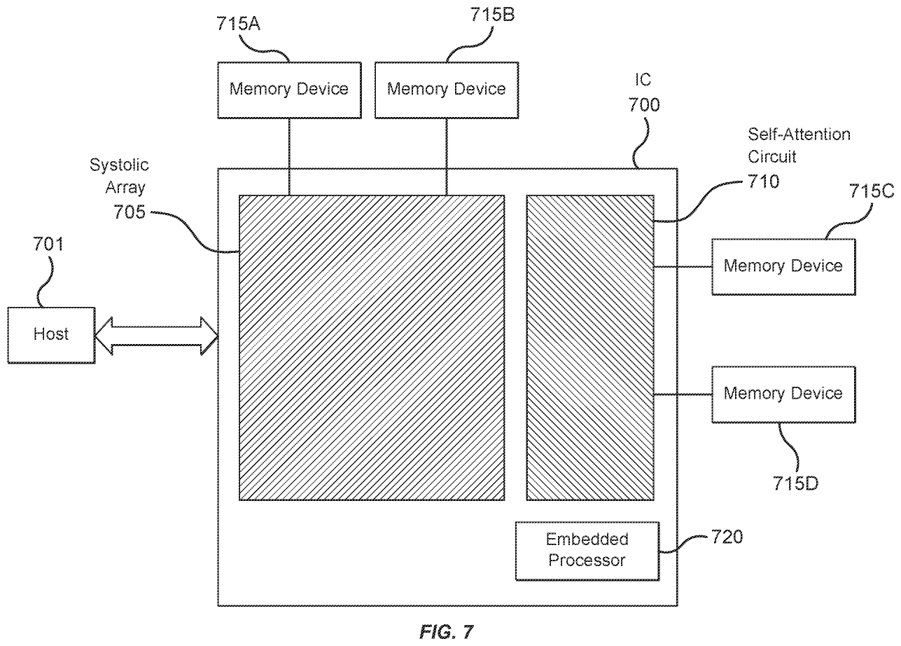

FIG. 1 illustrates a workflow 100 for executing a new AI model 140 on a model-specific chipset 150, according to one embodiment. The workflow 100 illustrates providing a template file 105 and weights 120 to a compiler 125. The template file 105 defines a base AI model 110 and new structural parameters 115 for the new AI model 140. In one embodiment, the structural parameters 115 indicate how to translate the structure of the base AI model 110 into the structure of the new AI model. For example, the base AI model 110 may be a first type of AI model, which has a different structure (e.g., different number of layers, different feed forward parameters, different caches, etc.) than the new AI model 140. For instance, the base AI model 110 may be a first type (or subcategory) of transformer model while the new AI model 140 is a second, different, type (or subcategory) of transformer model. While the base AI model 110 and the new AI model 140 are different types, they are both executable on the model-specific chipset 150, which, in this example, is optimized to execute only transformer-type AI models. For example, the chipset 150 may be designed or optimized to execute only transformer models but could execute other types of AI models although there is loss in efficiency. For instance, the chipset 150 may be able to run a standard deep neural network by not using a self-attention unit in the chipset 150 (e.g., a self-attention circuit 710 discussed in FIG. 7 below). The chipset 150 may also be able to execute AI networks with convolution layers although it may do so inefficiently relative to other hardware platforms (e.g., CPUs or GPUs).

As non-limiting examples, the new structural parameters 115 can describe a feed forward dimension, a cache size for keys (K) and values (V) (a KV cache), the activation function (e.g., RELU), whether a gated activation is used, the number of decoder layers, the number of heads, a maximum distance associated with performing attention, the number of buckets associated with self-attention, etc. These structural parameters 115 are examples for translating one type of transformer model to a new type of transformer model. These parameters 115 may be different if the workflow 100 is used for other types of AI models.

The template file 105 can include a text field for indicating the base AI model 110. The base AI model 110 is used as a template model for the new AI model 140. As described in more detail below, the architecture of the base AI model 110 is then modified using the parameters 115 to result in the architecture for the new AI model 140.

The template file 105 can use a variety for different formats. For example, the template file 105 can be thought of as a configuration file or as configuration data for the new AI model 140, but is not software code (e.g., is not assembly code or a high-level programming language). In one implementation, the template file 105 uses the JavaScript Object Notation (JSON) format, but this is just one suitable format that can be used and other data formats could be used such as XML.

The compiler 125 receives the template file 105 and weights 120 as inputs in order to generate executable code for the new AI model 140. In one embodiment, the compiler 125 scans the template file 105 to identify the base AI model 110 on which the new AI model 140 is translated or converted from. As shown, the compiler 125 includes a base model library 130 which stores AI models 135 that have already been compiled into executable code for the model-specific chipset 150. Put differently, the library 130 stores code (whether a high-level software programming language or executable code) for multiple AI models 135 that have already been compiled and executed on the model-specific chipset 150.

The code used to execute the base AI model 135 on the model-specific chipset 150 may be different than the code used to compile the base AI models 135 on a non-model-specific chipset such as central processing units (CPUs) or graphic processing units (GPUs). As such, the code used to compile the AI models 135 to execute on, e.g., a GPU, may not be usable to execute the AI models 135 on the model-specific chipset 150. In this example, the code stored in the library 130 can be used to execute the AI models 135 on the model-specific chipset 150. As such, the code can be used as a template to execute the new AI model 140 on the model-specific chipset 150.

Because the new AI model 140 is based on one or more of the AI models 135, this means the developer does not have to (directly) write code that executes on the model-specific chipset 150. Instead, the developer can provide the template file 105 that identifies the base AI model 110 and provides the structural parameters 115. In one embodiment, the compiler 125 performs a substitution where the new structural parameters 115 in the template file 105 replace the similar structural parameters for the AI model 135 in the base model library 130. That is, the compiler 125 matches the base AI model 110 in the template file 105 to one of the AI models 135 in the library 130. The compiler 125 can then replace the parameters in the code for the AI model 135 with the structural parameters 115 in the template file 105. This substitution can be performed in the high-level software programming language or in the executable code of the AI model 135 in the library 130. Further, this substitution can correspond to permutations of the code, and can include complex transformations.

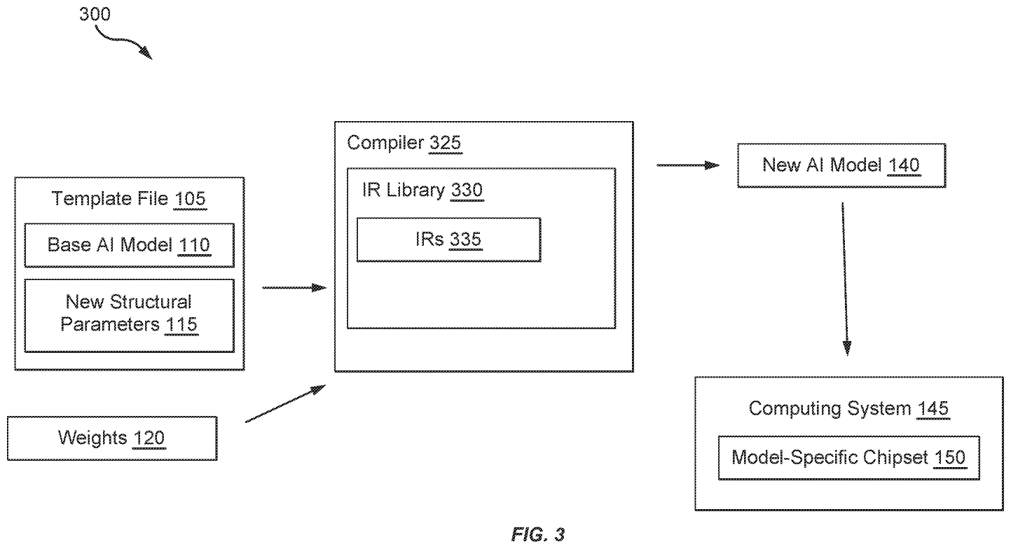

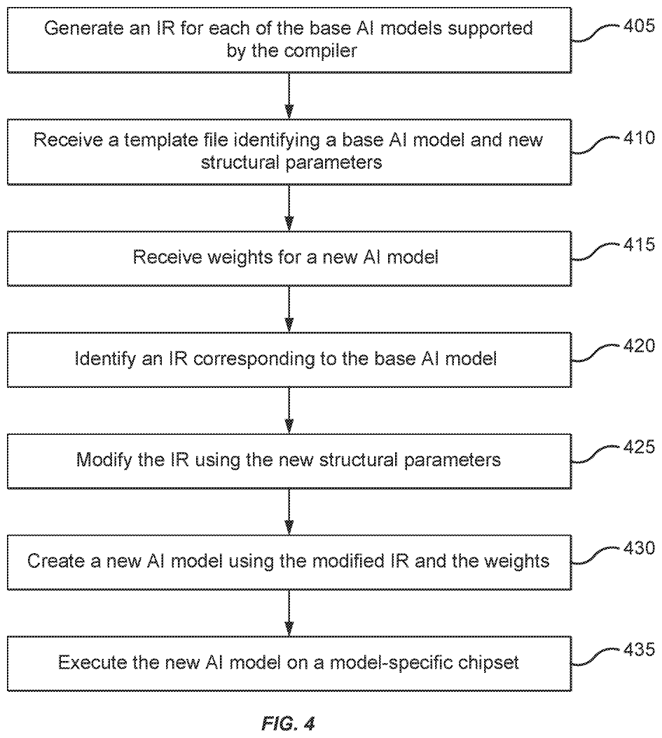

In another embodiment, the new structural parameters may be substituted into IRs, rather into code. This is discussed in more detail in FIGS. 3 and 4.

The compiler 125 can then output executable code for the new AI model 140. Specifically, the executable code can be executed on the model-specific chipset 150. In this manner, the developer can leverage code from a plurality of different AI models 135 in the library 130 to generate executable code for a new AI model 140. In one embodiment, the developer does not have to write any code themselves, but rather provides the template file 105. For example, the manufacturer of the model-specific chipset 150 can provide the base model library 130 to developers so they can choose a base model similar to their new AI model 140. The developer then provides the structural parameters 115 for converting the architecture/structure of one of the base AI models 135 into the new AI model 140.

After compiling the code for the new AI model code 140, executable code is provided to a computing system 145 that includes the model-specific chipset 150. In addition to including the model-specific chipset 150, the computing system 145 may include any number of processors (e.g., CPUs) that can include any number of processing cores. The computing system 145 can also include memory. The computing system 145 can be a single computing device, or can include a distributed computing system (e.g., a data center or a cloud computing environment). Further, the compiler 125 may be executed in the computing system 145 (or in a separate computing system).

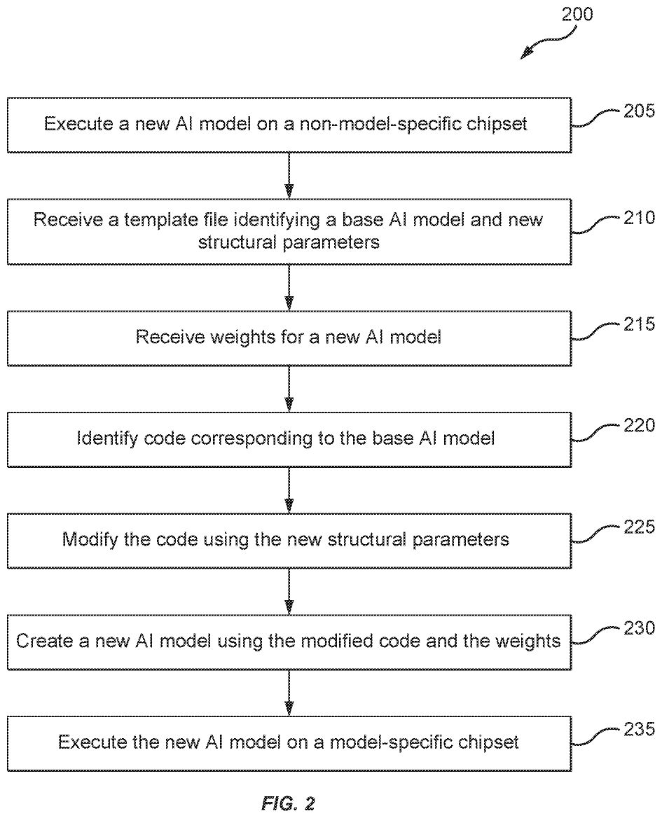

FIG. 2 is a flowchart of a method 200 for executing a new AI model on a model-specific chipset using a template file, according to one embodiment. At block 205, a new AI model is executed on a non-model specific chipset. For example, the developer may use the non-model specific chipset to train the new AI model but uses the model-specific chipset (e.g., the chipset 150 in FIG. 1) to perform inference using the trained AI model. For instance, the developer may use the non-model specific chipset to train the new AI model to obtain the weights 120 in FIG. 1 which are then used during inference when the AI model is executed on the model-specific chipset 150.

A non-model specific chipset can execute different types of AI models while a model specific chipset can execute only one type of AI model (or a very limited number of different types of AI models). Further, in one embodiment, the model-specific chipset may not be able to train the AI model. As such, the method 200 relies on the non-model specific chipset to train the AI model. However, in other embodiments, a model-specific chipset may be able to perform both training and inference. In that case, block 205 may be omitted.

At block 210, a compiler receives a template file (e.g., the template file 105 in FIG. 1) identifying a base AI model and structural parameters for the new AI model. As discussed below, the compiler uses the structural parameters to convert the base AI model into the new AI model.

In one embodiment, the base AI model listed in the template file matches an AI model stored in a library that is accessible to the compiler. For example, the base AI model listed in the template file may be limited to the AI models stored in the library. These AI models may be have been previously compiled and executed on the model-specific chipset.

At block 215, the compiler receives weights for the new AI model. In one example, the weights may have been obtained at block 205 when the new AI model was executed on the non-model-specific chipset during training.

At block 220, the compiler identifies code corresponding to the base AI model. In one embodiment, the compiler matches the base AI model listed in the template file to one of the AI models in the library. In one embodiment, the AI models in the library are different AI models but all fall within the same type or category of AI model (e.g., are all transformer models). For example, the library may store sequence-to-sequence models, autoregressive models, or autoencoding models which are different types of transformer models. These different types can be referred to as different subcategories of transformer models.

At block 225, the compiler modifies the code using the new structural parameters. For instance, the compiler may substitute the values of the new structural parameters into the code. This substitution may be performed in a high-level software programming language or in executable code. For example, the compiler may change, in the code of the base AI model, the value of a feed forward dimension, change a KV cache size, specify an activation function to use, specify whether the use a gated activation, change the number of decoder layers, change the number of heads, and so forth, using the values in the new structural parameters. In this manner, values in the code for the base AI model are replaced with values in the structural parameters.

At block 230, the compiler creates a new AI model using the modified code and the weights. That is, performing the substitution above changes the architecture and/or the structure of the base AI model so that the resulting executable code now defines the new AI model.

At block 235, the model-specific chipset executes the new AI model using the code output by the compiler.

FIG. 3 illustrates a workflow 300 for executing a new AI model on a model-specific chipset using IRs, according to one embodiment. The workflow 300 includes many of the same elements as the workflow 100 in FIG. 1, as indicated by using the same reference numbers. However, the workflow 300 includes a different compiler 325 which instead of having a base AI model library, includes an IR library 330 that stores IRs 335 corresponding to the base AI models. In one embodiment, the IR library 330 stores one IR 335 for each base AI model that is supported by the compiler 325.

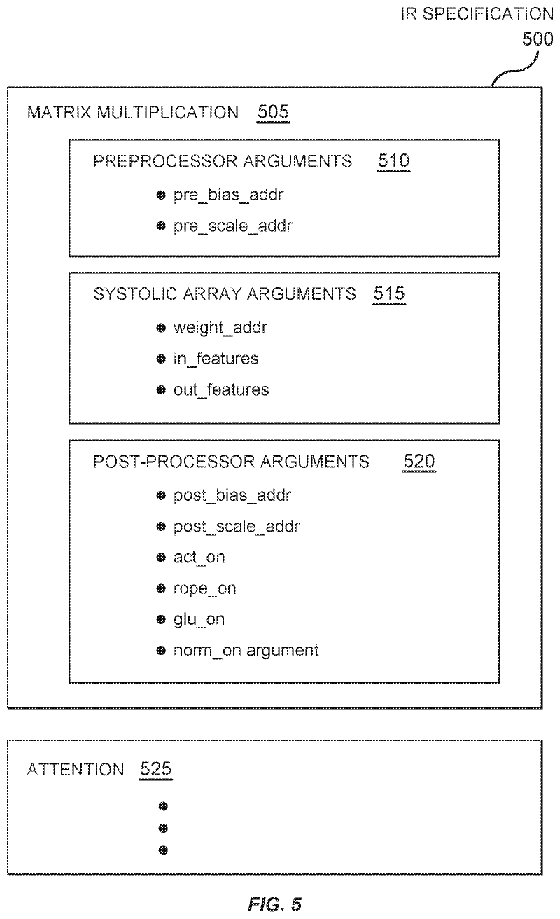

In one embodiment, each IRs 335 provides values of arguments that configure the model-specific chipset 150 to perform a corresponding base AI model. That is, instead of storing the code for the base AI models in a library, the IR library 330 stores an IR 335 for each base AI model. The IR 335 can include values for various parameters to perform, for example, matrix multiplication or attention as part of a base AI model. The IRs 335 can use any type of suitable data format—e.g., JSON. The IRs 335 will be discussed in more detail in FIGS. 4 and 5.

As shown, the compiler 325 receives the template file 105 and the weights 120 for the new AI model 140. Like above, the compiler 325 searches the template file 105 to identify the base AI model 110. Once identified, the compiler 325 can search the IR library 330 to identify the IR 335 corresponding to the base AI model 110. That is, the compiler 325 can support any base AI model 110 that has a corresponding IR 335 stored in the IR library 330.

The compiler 325 substitutes the values in the IR 335 for the base AI model 110 with the values of the structural parameters 115 in the template file 105. For example, the IR 335 may include data arguments for defining the different functions performed by the base AI model. That is, the IRs 335 each includes values of arguments that configure the model-specific chipset 150 to perform operations for the respective base AI model. The values of these data arguments are replaced with the values of the structural parameters 115 so that the IR 335 now corresponds to the new AI model 140. The compiler 325 can then compile the modified IR to result in executable code for the new AI model 140. In this manner, an IR 335 for a base AI model that executes on the model-specific chipset 150 can be modified and compiled to result in code for a new AI model that also runs on the model-specific chipset 150.

FIG. 4 is a flowchart of a method 400 for executing a new AI model on a model-specific chipset using an IR, according to one embodiment. At block 405, the compiler (or a developer) generates an IR for each of the base AI models that are, or will be, supported by the compiler. Like above in FIGS. 1 and 2, the base AI models can be AI models that have been previously compiled and executed on the model-specific chipset. In one embodiment, the IRs for the base AI models may have been generated when the models were compiled. In another embodiment, a software developer (e.g., a developer for the manufacturer of the model-specific chipset) may create the IRs to make it easy for a customer to execute new AI models on the model-specific chipset.

FIG. 5 illustrates a portion of an exemplary IR specification 500, according to one embodiment. The IR specification 500 can be used to generate the IRs at block 405 of the method 400.

The IR specification 500 includes a matrix multiplication section 505 and an attention section 525. The IR specification 500 is a specific example of a specification that can be used with a transformer model where each function is defined either as a matrix multiplication operation or an attention operation. An IR specification 500 for a different type of model may have different sections than what is shown in FIG. 5.

The IR specification 500 illustrates different arguments for the matrix multiplication section 505. These arguments include preprocessor arguments 510, systolic array arguments 515, and post-processor arguments 520. The preprocessor arguments 510 include arguments used to configure the model-specific chipset to perform the matrix multiplication operation. As non-limiting examples, the arguments 510 can include the memory address of a bias vector (pre_bias_addr) and the memory address of a scale vector (pre_scale_addr). These are just a few of the examples of preprocessor arguments 510 that may be used when translating a specialized function into an IR.

The systolic array arguments 515 can include arguments used to configure a systolic array in the chipset to perform the matrix multiplication. These arguments 515 can include a memory address of a weight matrix (weight_addr), a length of the input (in_features), and a length of the output (out_features). These are just a few of the examples of systolic array arguments 515 that may be used when translating a specialized function into an IR.

The post-processing arguments 520 configure the chipset to prepare for the next operation after the matrix operation has completed. These arguments 520 can include memory address of the bias vector after the matrix multiplication is complete (post_bias_addr), the memory address of a scale vector after the matrix multiplication is complete (post_scale_addr), determining whether an activation function is performed after the matrix multiplication is complete (act_on), determining whether Rotary Positional Embedding (RoPE) is used (rope_on), determine whether a Gated Linear Unit (GLU) variant is used (glu_on), and a Boolean value determining whether normalization will be applied in the current layer (norm_on argument). These are just a few of the examples of post-processing arguments 520 that may be used when translating a specialized function into an IR.

The IR indicates the values of the arguments 510, 515, and 520 for executing a base AI model on the model-specific chipset. That is, the value of the arguments 510, 515, and 520 may be different for different ones of the base AI models. For example, for a first AI model, an activation may not be performed after the matrix multiplication. In that case, the IR includes a value of “zero” for act_on in the post-processing arguments 520. However, a second AI model may perform an activation after matrix multiplication in which case its IR indicates a value of “one” for act_on. The compiler can use the AI model code to identify the values of the arguments 510, 515, and 520 (e.g., memory addresses, lengths on input/output data, whether RoPE or GLU is used, and so forth). Once the values of the arguments 510, 515, and 520 are identified, this creates an IR for the base AI model. This can be repeated to create an IR for each of the base AI models supported by the chipset.

Moreover, some of the base AI models may not include all of the arguments 510, 515, and 520 in the specification 500. For example, if a base AI model does not use ROPE, then the value of the rope_on parameter in its IR may be null, or be omitted. In this manner, the IR contains the values of the arguments and parameters in the IR specification 500 for a particular base AI model.

Returning to the method 400, at block 410 the compiler receives a template file identifying a base AI model and new structural parameters. As discussed below, the compiler uses the structural parameters to convert an IR for the base AI model into an IR for the new AI model.

At block 415, the compiler receives weights for the new AI model. In one example, the weights may have been obtained when the new AI model was executed on the non-model-specific chipset during training.

At block 420, the compiler identifies an IR corresponding to the base AI model. In one embodiment, the base AI model listed in the template file matches an AI model that has an IR stored in an IR library (e.g., the library 330 in FIG. 3) that is accessible to the compiler. For example, the developer may be limited to the AI models that have IRs stored in the library. The compiler can retrieve the IR for the base AI model from the IR library.

At block 425, the compiler modifies the IR for the base AI model using the new structural parameters in the template file. For example, the IR for the base AI model may have a first set of values for the various arguments shown in the IR specification 500 in FIG. 5. The compiler uses the structural parameters to replace some or all of the values in the IR for the base AI model to convert it into an IR for the new AI model. That is, after performing this modification, the IR now has the values for various arguments to perform, for example, matrix multiplication or attention as part of the new AI model.

At block 430, the compiler uses the modified IR and the weights to create a new AI model. For example, the compiler can use the modified IR and the weights to generate executable code for the new AI model that is specially designed to execute on the model-specific chipset.

At block 435, the model-specific chipset executes the new AI model. In this manner, the method 400 leverages an IR for a base AI model which has already been executed on the model-specific chipset to generate executable code for a new AI model.

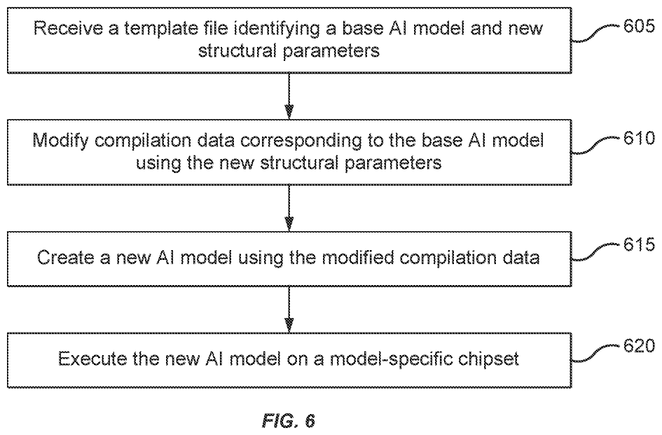

FIG. 6 is a flowchart for a method 600 for executing a new AI model on a model-specific chipset using a template file, according to one embodiment. At block 605, a compiler receives a template file (e.g., the template file 105 in FIG. 1) identifying a base AI model and structural parameters 115 for the new AI model. As discussed below, the compiler uses the structural parameters to convert the base AI model into a new AI model.

In one embodiment, the compiler may also receive weights for the new AI model. These weights may have been generated when training the new AI model, which may have occurred before the method 600 is performed. The new AI model could have been trained using a non-model specific chipset (e.g., a CPU or GPU) or using the model-specific chipset.

At block 610, the compiler modifies compilation data corresponding to the base AI model using the new structural parameters. In one embodiment, the compilation data can be code corresponding to the base AI model, as discussed in FIGS. 1 and 2. For instance, the compiler may substitute the values of the new structural parameters into the code. This substitution may be performed in a high-level software programming language or in executable code.

In another embodiment, the compilation data can be an IR corresponding to the base AI model, as discussed in FIGS. 3-5. For example, the IR for the base AI model may have a first set of values for the various arguments shown in the IR specification 500 in FIG. 5. The compiler can use the new structural parameters in the template file to replace some or all of the values in the IR for the base AI model to convert it into an IR for the new AI model. That is, after performing this modification, the IR now has the values for various arguments to perform, for example, matrix multiplication or attention as part of the new AI model.

In one embodiment, the compiler can use the structural parameters to modify both code corresponding to the base AI model and an IR corresponding to the base AI model. Put differently, the compiler can perform a combination of the modifying code and modifying an IR for the base AI model.

At block 615, the compiler creates a new AI model using the modified compilation data. For instance, the compiler can create executable code for the new AI model using the modified compilation data.

At block 620, the model-specific chipset executes the new AI model using the code provided by the compiler.

FIG. 7 illustrates an IC 700 with a systolic array 705 and a self-attention circuit 710, according to one embodiment. The IC 700 is one example of an IC in a model-specific chipset as discussed in FIGS. 1-6. For example, the IC 700 may be a transformer model IC that can execute only transformer models.

In this example, the IC 700 is coupled to a host 701 which can be a computing device (e.g., a server) or multiple computing devices. For example, the system may be deployed in a cloud computing data center with multiple hosts 701 (e.g., multiple computing devices) and multiple instances of the IC 700. In one embodiment, the host 701 and the IC 700 are disposed in the same form factor, but this is not a requirement.

Although not shown, the host 701 can include multiple processors (e.g., CPUs) and memory. For example, the host 701 may execute an operating system that communicates with the IC 700 using the PCIe connections. In one embodiment, the IC 700 is part of an accelerator such as a ML/AI accelerator. In one embodiment, the host 701 executes a software program that offloads AI/ML tasks to the IC 700 as part of inference and receives the results from executing those tasks on the systolic array 705 and the self-attention circuit 710. In one embodiment, the host 701 can communicate with (e.g., offload task to) multiple, different AI accelerators which may be optimized for different AI models.

The IC 700 includes an embedded processor 720 that receives executable code for the AI model (e.g., a transformer model)—e.g., the executable code discussed in FIGS. 1-6. The code instructs the embedded processor 720 to configure the hardware in the IC 700 to implement the fused kernels discussed above.

The host 701 can use any other suitable interconnect to transmit data to, and receive data from, the systolic array 705. In one example, the host 701 transmits data to a leftmost column of the systolic array 705 in the IC 700 to start a task for an application (e.g., an AI application) executing on the host 701. When the IC 700 is used as an AI accelerator for a language model, an application on the host 701 can submit an embedding vector corresponding to a piece of data (e.g., a group of characters, an embedding of a part of an image, or metadata) to the leftmost column of the systolic array 705. While the connections between the host 701 and the IC 700 can be used to load data into the systolic array 705, in one embodiment, the systolic array 705 does not take instructions at runtime, and only executes instructions in a preset loop.

In one embodiment, the systolic array 705 includes rows and columns of DPUs. As such, the systolic array 705 can perform different operations for a single layer in an AI model, or perform operations for different layers in the AI model, simultaneously.

In this example, the systolic array 705 is coupled to two memory devices-memory device 715A and 715B. In one embodiment, the memory devices 715 are High Bandwidth Memories (HBMs), but this is not a requirement. When used in an AI accelerator application, the memory devices 715A and 715B can store the weights for the AI model being used at runtime. The weights can be provided by the memory devices 715A and 715B to a top row of DPUs in the systolic array 705 where the weights are passed down through the rows of the systolic array 705. In one embodiment, the weights are constant when executing the systolic array 705. Nonetheless, although not shown, the system may include additional connections between the memory devices 715A and 715B and the host 701 so that an application on the host 701 can update the data (e.g., weights) stored in the memory devices 715A and 715B. Although FIG. 7 illustrates connecting two memory devices to the systolic array 705, one, three, four, etc. memory devices can be connected to the array 705.

The self-attention circuit 710 may be specialized circuitry to perform accelerator functions that are not efficiently performed by the systolic array 705. As a non-limiting example, for AI accelerators, self-attention operations use data computed from previous tokens, which means such data should be saved. Most of the parts of a transformer model do not use data from previous tokens (i.e., previous data sequences), and thus, can be calculated efficiently using the systolic array 705 which may consider each token in isolation from the other tokens being computed on. However, for operations that do use previous data computed from previous tokens, these operations can be delegated to the self-attention circuit 710. For example, a self-attention operation may require each row of a token to be multiplied by a different matrix where the different matrix is determined by data computed from previous tokens.

The self-attention circuit 710 is not limited to any particular type of circuit. Indeed, the function of the self-attention circuit 710 may change depending on the type of AI model being executed on the accelerator device. In one embodiment, the self-attention circuit 710 could be a separate systolic array (which has access to its own memory devices 715C and 715D), or could be a different type of processing element (e.g., a micro-processor, a controller, an arithmetic-logic unit (ALU), and the like).

As shown, the self-attention circuit 710 is coupled to the memory devices 715C and 715D (e.g., one or more HBMs). In other examples, the self-attention circuit 710 can be coupled to as many memory devices 715 as needed to complete the specific attention operation, or is permitted by packaging techniques. Because there are many different types of self-attention algorithms, each with their own memory capacity and bandwidth requirements, attaching the self-attention circuit 710 to as many memory devices 715 as possible can enable the accelerator device to support a greater number of such algorithms. For example, the self-attention circuit 710 could be coupled to memory devices disposed on multiple sides of the IC 700.

In one embodiment, the memory devices 715 are connected to the ICs 700 through a substrate, such as an interposer. Alternatively, the memory devices 715 can be stacked directly on the IC 700. For example, HBMs are themselves a stack of DRAM dies with an optional base die. The DRAM dies in the HBMs can be interconnected by through-silicon vias (TSVs) and microbumps. The HBMs can be disposed on the IC 700 directly and connect to the IC 700 using microbumps.

An HBM3 module is composed of 16 different channels that can operate completely independently. In one embodiment, of portion of those channels are dedicated for storing weights used by the systolic array 705 while other channels are used for some other purpose, such as memory for the self-attention circuit 710.

Further, in some embodiments, the memory devices 715A and 715B for the systolic array 705 may not be needed. Instead, the host 701 can provide the input data and weight data for both the X direction (e.g., by providing data to the leftmost column of the systolic array 705) and the Y direction (e.g., by providing weight data to the topmost row of the systolic array 705) using, e.g., the PCIe connections.

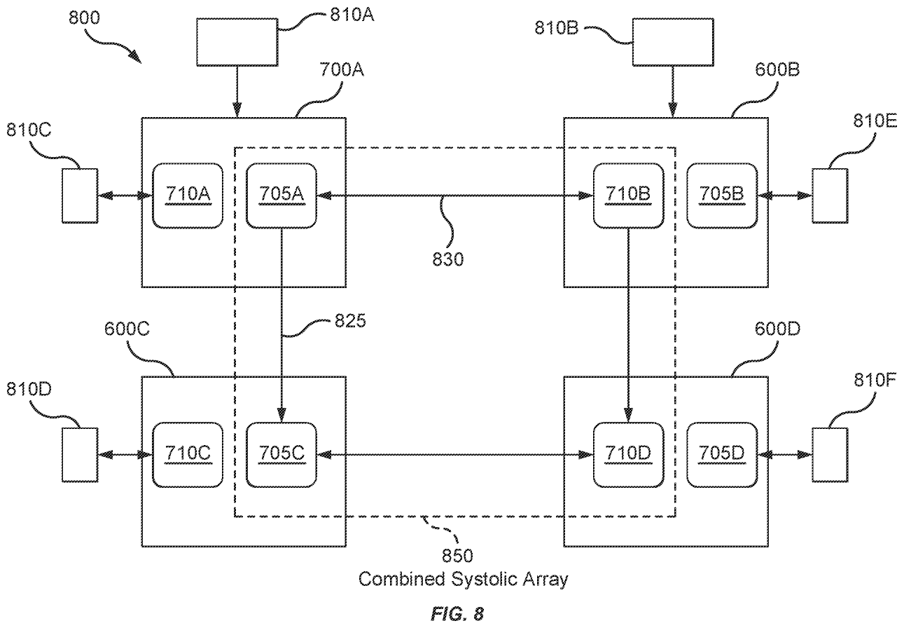

FIG. 8 illustrates a package 800 with a combined systolic array formed using a plurality of ICs 700, according to one embodiment. The package 800 is one example of a model-specific chipset as discussed in FIGS. 1-6. For example, the package 800 (and the plurality of ICs 700 in the package 800) may be able to execute only transformer models.

FIG. 8 illustrates four ICs 700A-D which each includes a systolic array 705A-D and a self-attention circuit 710A-D which were described in FIG. 7. In this embodiment, the local systolic arrays 705 in the ICs 700 are combined to form a larger, combined systolic array 850. For example, from the perspective of the host, the systolic array 850 appears to be one large array, even though it is physically made up of smaller local systolic arrays 705 distributed on separate ICs 700. In one embodiment, the ICs 700 are all identical.

The local systolic arrays 705 can be interconnected using horizontal and vertical chip-to-chip connections 825 and 830. In one embodiment, the horizontal connections 830 are bidirectional which permits data to flow from left to right and from right to left, while the vertical connections 825 are unidirectional which permits data to flow only from top to bottom (not from bottom to top). The chip-to-chip connections 825 and 830 are not limited to any particular type of connection, so long as the connection permits the flow of data between the local systolic arrays 705 so that the DPUs can output data each clock cycle. In one embodiment, Universal Chiplet Interconnect Express (UCIe) can be used to form the chip-to-chip (or die-to-die) connections 825 and 830, which has a physical layer that supports up to 32 GT/s with 16 to 64 lanes.

Further, the top row of the ICs (i.e., IC 700A and 700B) can be connected to memory chips 810. While FIG. 8 illustrates connecting the ICs 700 in the top row to one memory chip 810, they can be connected to any number of memory chips 810.

As shown, the self-attention circuits 710 in each IC 700 is coupled to at least one local memory chip 810 (e.g., one or more HBMs). In other examples, the self-attention circuits 710 in each of the ICs 700 can be coupled to as many local memories 810 as needed to complete the specific operation, or is permitted by packaging techniques. Because there are many different types of self-attention algorithms, each with their own memory capacity and bandwidth requirements, attaching self-attention circuits 710 to as many local memory chips 810 as possible can enable the accelerator device to support a greater number of such algorithms.

For example, four local memory chips 810 could be disposed around each IC 700—e.g., two memory chips 810 on opposite sides, or one memory chip 810 disposed on each side. Further, in one embodiment, the ICs 700 may be attached to the same number of local memory chips 810. However, in other embodiments, the ICs 700 may be coupled to different number of local memory chips 810.

In one embodiment, the local systolic arrays 705 do not have access to some of the local memory chips 810, and the self-attention circuits do not have access to some of the local memory chips 810. For example, only the self-attention circuit 710A may be able to access the local memory chip 810C, while only the systolic array 705A can access the local memory chip 810A. However, in other examples, the local systolic arrays 705 and the self-attention circuits 710 can access every memory chip connected to the IC 700. For instance, instead of (or in addition to) using local SRAM on the IC 700A, the local systolic array 705A may use the memory chip 810C as scratchpad space when performing their operations.

In one embodiment, the self-attention circuits 710 in one IC 700 cannot directly communicate with the self-attention circuits 710 in another IC 700. For example, the self-attention circuits 710 in each IC 700 may operate independently of each other. Instead, the self-attention circuits 710 in each IC 700 may interface with the local systolic array 705 on the same IC 700 in order to pass data and results to the self-attention circuits 710 in other ICs 700. Alternatively, the self-attention circuits 710 in the ICs 700 may be interconnected to each other using the horizontal and vertical chip-to-chip connections 825, 830 in a same or similar way as the local systolic arrays 705 are interconnected to form the combined systolic array 850.

In one embodiment, the package 800 may include a silicon wafer interposer or conventional PCB substrate on which the ICs 700 are disposed in grid-like pattern. The chip-to-chip connections 825 and 830 may be formed in the interposer. However, in another embodiment, the ICs 700 may be formed in a stack, rather than being disposed side-by-side as shown in FIG. 8. For example, the systolic array 850 may include just one row of the ICs 700 where the ICs 700 are stacked on top of each other. Micro bumps or copper pillars can be used to form the chip-to-chip connections directly between the ICs 700 in the stack to form a combined systolic array 850 from the local systolic arrays 705 in each of the ICs 700.

In one embodiment, the bandwidth of the connection of the horizontal chip-to-chip connections 830 is different for data flowing from left to right relative to data flowing from right to left. In one example, the connections 830 may provide much higher data rates for data moving from left to right than the data rates for transferring data right to left. For example, the systolic array 850 may use the right to left bandwidth to return results generated by the ICs 700 in the rightmost column back to the inputs of the systolic array 850 at the ICs 700 in the leftmost column. As a non-limiting example, the left-to-right data paths in the horizontal connections 830 may support data streams of hundreds of GBs, while the right-to-left data paths in the horizontal connections 830 may support data streams of tens of GBs (or less). Furthermore, the left-to-right data paths in the horizontal connections 830 may have a fairly constant utilization while the right-to-left data paths may be bursty (e.g., used when the computation for a row vector has been completed and the resultant values are being fed back to the leftmost input column of ICs 700).

The size of the local systolic arrays 705 can vary. For example, the arrays 705 can have sizes of approximately 100-10000 rows and 100-10000 columns of DPUs. However, this can vary depending on the overall physical size of the ICs 700, the process node used to fabricate the ICs 700 (e.g., 7 nm, 10 nm, 14 nm, 22 nm, 32 nm, etc.) and the other circuitry in the ICs 700 beside the local systolic arrays 705—e.g., the size of the self-attention circuits 710.

The package 800 can include any number of the ICs 700, which can have any number of rows and columns. For example, the combined systolic array 850 may be formed from a single row of ICs 700, or from a single column of ICs 700. In that case, assuming each IC 700 has a local systolic array 705 of dimensions 100×100 (measured in terms of DPUs within the systolic arrays 705), a single row of four ICs 700 would form a 100×400 combined systolic array 850 while a single column of four ICs 700 would form a 400×100 combined systolic array 850. Different packages 800 may have different sizes of systolic arrays 850 depending on their applications (e.g., depending on the type of computation being performed). Moreover, the physical limitations of current packaging techniques and IC technology may limit the number of ICs 700 that can be disposed in the same package 800.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving a template file identifying a base artificial intelligence (AI) model and structural parameters corresponding to a second AI model, wherein the base AI model has been previously compiled to execute on a model-specific chipset;
modifying compilation data corresponding to the base AI model using the structural parameters;
creating, at a compiler, executable code for the second AI model using the modified compilation data; and
executing the second AI model on the model-specific chipset using the executable code.

2. The method of claim 1, further comprising, after receiving the template file but before modifying the compilation data:
identifying code corresponding to the base AI model stored in a library,
wherein modifying the compilation data comprises:
replacing values in the code for the base AI model with values in the structural parameters.

3. The method of claim 2, wherein the library stores code for a plurality of base AI models that are supported by the compiler, wherein the plurality of base AI models have each been previously executed on the model-specific chipset.

4. The method of claim 1, further comprising, after receiving the template file but before modifying the compilation data:
identifying an intermediate representation (IR) corresponding to the base AI model that is stored in a library,
wherein modifying the compilation data comprises:
replacing values in the IR with values in the structural parameters to generate a modified IR.

5. The method of claim 4, wherein the modified IR has values for various arguments to perform operations that are part of the second AI model.

6. The method of claim 4, wherein the library stores IRs for a plurality of base AI models that are supported by the compiler, wherein the plurality of base AI models have each been previously executed on the model-specific chipset, wherein the IRs each comprises values of arguments that configure the model-specific chipset to perform operations for a respective base AI model.

7. The method of claim 1, wherein the template file does not include software code for a programming language.

8. The method of claim 7, wherein data in the template file uses a JavaScript Object Notation (JSON) format.

9. The method of claim 1, wherein structural parameters change an architecture or structure of the base AI model to convert the base AI model into the second AI model.

10. The method of claim 1, wherein the base AI model and the second AI model are different types of transformer models, wherein the model-specific chipset can is optimized to execute only transformer models.

11. A non-transitory computer readable medium having program instructions embodied therewith, the program instructions executable by a processor to perform an operation, the operation comprising:
receiving a template file identifying a base artificial intelligence (AI) model and structural parameters corresponding to a second AI model, wherein the base AI model has been previously compiled to execute on a model-specific chipset;
modifying compilation data corresponding to the base AI model using the structural parameters;
creating, at a compiler, executable code for the second AI model using the modified compilation data; and
executing the second AI model on the model-specific chipset using the executable code.

12. The non-transitory computer readable medium of claim 11, wherein the operation further comprises, after receiving the template file but before modifying the compilation data:
identifying code corresponding to the base AI model stored in a library,
wherein modifying the compilation data comprises:
replacing values in the code for the base AI model with values in the structural parameters.

13. The non-transitory computer readable medium of claim 12, wherein the library stores code for a plurality of base AI models that are supported by the compiler, wherein the plurality of base AI models have each been previously executed on the model-specific chipset.

14. The non-transitory computer readable medium of claim 11, wherein the operation further comprises, after receiving the template file but before modifying the compilation data:
identifying an intermediate representation (IR) corresponding to the base AI model that is stored in a library,
wherein modifying the compilation data comprises:
replacing values in the IR with values in the structural parameters to generate a modified IR.

15. The non-transitory computer readable medium of claim 14, wherein the modified IR has values for various arguments to perform operations that are part of the second AI model,
wherein the library stores IRs for a plurality of base AI models that are supported by the compiler, wherein the plurality of base AI models have each been previously executed on the model-specific chipset, wherein the IRs each comprises values of arguments that configure the model-specific chipset to perform operations for a respective base AI model.

16. The non-transitory computer readable medium of claim 11, wherein the base AI model and the second AI model are different types of transformer models, wherein the model-specific chipset is optimized to execute only transformer models.

17. A system, comprising:
one or more processors; and
one or more memories storing a compiler which, when executed by the one or more processors, performs an operation comprising:
receiving a template file identifying a base artificial intelligence (AI) model and structural parameters corresponding to a second AI model, wherein the base AI model has been previously compiled to execute on a model-specific chipset;
modifying compilation data corresponding to the base AI model using the structural parameters; and
creating executable code for the second AI model using the modified compilation data, wherein the executable code, when executed on the model-specific chipset, performs the second AI model.

18. The system of claim 17, wherein the operation further comprises, after receiving the template file but before modifying the compilation data:
identifying code corresponding to the base AI model stored in a library,
wherein modifying the compilation data comprises:
replacing values in the code for the base AI model with values in the structural parameters,
wherein the library stores code for a plurality of base AI models that are supported by the compiler, wherein the plurality of base AI models have each been previously executed on the model-specific chipset.

19. The system of claim 17, wherein the operation further comprises, after receiving the template file but before modifying the compilation data:
identifying an intermediate representation (IR) corresponding to the base AI model that is stored in a library,
wherein modifying the compilation data comprises:
replacing values in the IR with values in the structural parameters to generate a modified IR,
wherein the modified IR has values for various arguments to perform operations that are part of the second AI model, and
wherein the library stores IRs for a plurality of base AI models that are supported by the compiler, wherein the plurality of base AI models have each been previously executed on the model-specific chipset, wherein the IRs each comprises values of arguments that configure the model-specific chipset to perform operations for a respective base AI model.

20. The system of claim 17, wherein the base AI model and the second AI model are different types of transformer models, wherein the model-specific chipset is optimized to execute only transformer models.
